(19) United States
(12) Patent Application Publication
(10) Pub. No.: US 2008/0104746 A1
(43) Pub. Date: May 8, 2008

(54) Bathtub system

(76) Inventor: Karen Stewart, Brooklyn, NY (US)

Correspondence Address: LAW OFFICES OF ALOZIE N. ETUFUGH, PLLC, 30 CENTRAL PARK SOUTH, NEW YORK, NY, 10019, US

(21) Appl. No.: 11/998,061

(22) Filed: Nov. 27, 2007

Related U.S. Application Data
(62) Division of application No. 11/525,465, filed on Sep. 22, 2006.

(51) Int. Cl. A61H 33/02

(52) U.S. Cl. 4/545

(57) ABSTRACT

A bathtub system is disclosed. The first bathtub has a plurality of side portions. The plurality of side portions of the first bathtub having a plurality of openings. A second bathtub is disposed underneath the first bathtub wherein the second bathtub overlaps the plurality of side portions of the first bathtub, where an opening space is defined between the second bathtub and the first bathtub. The plurality of side portions are configured to receive a plurality of liquids. The opening space between the second bathtub and the first bathtub includes a heating device. The heating device is configured to heat the plurality of liquids to transform the plurality of liquids into a gas. The gas is released through the plurality of openings in the plurality of side portions.

### CROSS REFERENCE TO RELATED APPLICATIONS

This application is a Divisional application to utility application Ser. No. 11/525,465 entitled, “Bathtub System” filed Sep. 22, 2006 by Karen Stewart.

### FIELD OF INVENTION

This invention relates to a bathtub system.

### BACKGROUND OF THE INVENTION

Generally, households, such as apartments and houses have bathtubs and/or showers where persons use them to clean and wash themselves. In some instances, the bathtubs and showers are replaced with whirlpool systems that are becoming more and more common. The whirlpool systems allow a person to enjoy a bath while bubbles are being circulated around the person to massage the person, which provides the person with an enjoyable and soothing experience.

Even though the whirlpool systems, provide the user with an enjoyable experience the whirlpool systems does not provide all the needs of the user. For example, the whirlpool moves the water in a wavelike motion that massages the person, but it does not provide a means to aid a person that may be suffering from asthma, sinus troubles or stuffy noses due to colds. The whirlpool systems do not provide a means to relieve the aforementioned ailments because it only circulates water in a wave like motion.

Therefore, there is a need for a bathtub system or whirlpool system that includes a design that is capable of helping a person with asthma sinus troubles or a stuffy nose.

### BRIEF SUMMARY OF THE INVENTION

The present invention has been accomplished in view of the above-mentioned technical background, and it is an object of the present invention to provide a system that is able to provide a person with a way to deal with ailments, such as asthma and sinus trouble.

In a preferred embodiment of the invention, a bathtub system is disclosed. The first bathtub has a plurality of side portions. The plurality of side portions of the first bathtub having a plurality of openings. A second bathtub is disposed underneath the first bathtub wherein the second bathtub overlaps the plurality of side portions of the first bathtub, where an opening space is defined between the second bathtub and the first bathtub. The plurality of side portions are configured to receive a plurality of liquids. The opening space between the second bathtub and the first bathtub includes a heating device.

The heating device is configured to heat the plurality of liquids to transform the plurality of liquids into a gas. The gas is released through the plurality of openings in the plurality of side portions.

In another preferred embodiment of the invention, a method of utilizing the bathtub system is disclosed. A first bathtub is provided that has a plurality of side portions. The plurality of side portions of the first bathtub is provided with a plurality of openings. A second bathtub is provided that is disposed underneath the first bathtub where the second bathtub overlaps the plurality of side portions of the first bathtub, wherein an opening space is defined between the second bathtub and the first bathtub. The plurality of side portions receives a plurality of liquids, where the opening space between the second bathtub and the first bathtub includes a heating device. The heating device is configured to heat the plurality of liquids to transform the plurality of liquids into gas. The gas is released through the plurality of openings in the plurality of side portions.

In another preferred embodiment of the invention, a method of utilizing a bathtub system is disclosed. A plurality of liquids is received. The plurality of liquids is heated based on a particular amount of the plurality of liquids received. The plurality of liquids are transformed into gas responsive to the plurality of liquids being heated to a certain temperature. The gas is released to a plurality of openings.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 Illustrates an exploded view of a bathtub system in accordance with an embodiment of the invention.

FIG. 2 Illustrates a flow chart of how the bathtub system of FIG. 1 is employed in accordance with an embodiment of the invention.

### DETAILED DESCRIPTION OF THE INVENTION

The presently preferred embodiment of the invention are described with references to the drawings, where like components are identified with the same numerals. The descriptions of the preferred embodiments are exemplary and are not intended to limit the scope of the invention.

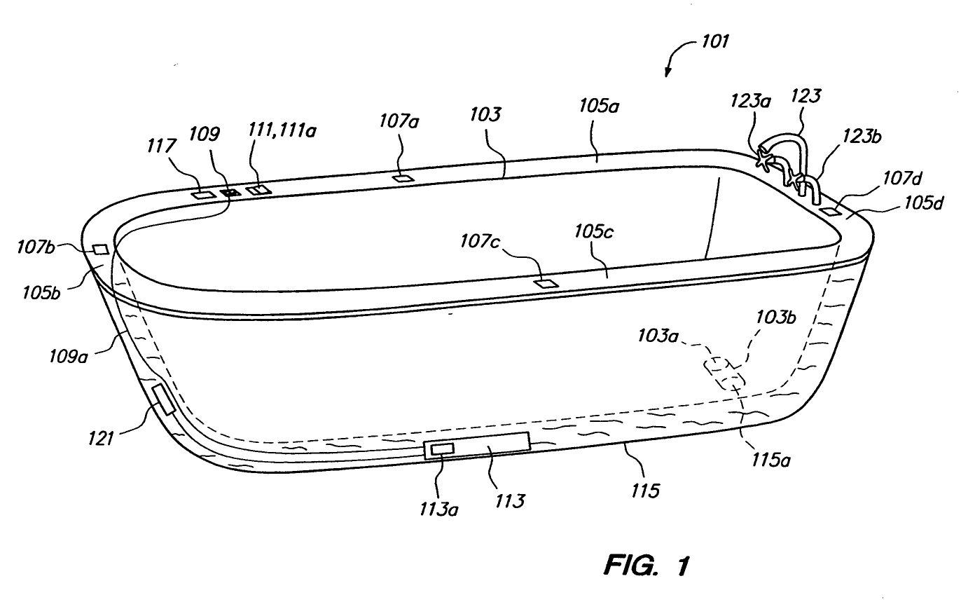

FIG. 1. Illustrates an exploded view of the bathtub system. The bathtub system 101 includes a first bathtub 103. A first bathtub drain 103a, a left side portion 105a, a right side portion 105c, a front side portion 105d, a back side portion 105b, a switch 109, a heating device 113, a second bathtub 115, a faucet 123, a second bathtub drain 115a. Faucet 123 is a typical faucet 123 associated with a typical bathtub. Faucet 123 includes a standard hot water faucet turning mechanism 123a and a standard cold water faucet turning mechanism 123b where hot and cold water flows from typical pipes (not shown), associated with a standard bathtub, coupled to the faucet 123 into the first bathtub 103. When the water is in the first bathtub 103 it is utilized for bathing and the like, then the water and other materials are dispensed through the first bathtub drain 103a through a valve 103b, in between the first bathtub 103 and the second bathtub 115, into the second bathtub drain 115a where the water and other materials are dispensed into a typical sewer system and the like. This bathtub system 101 can be used as a regular bathtub where only the first bathtub 103 and second bathtub 115 are utilized only to take a bath. Otherwise, the bathtub system 101 is used as a bathtub and a way to have a steam bathtub or vapor bathtub as described below.

The first bathtub 103 and the second bathtub 115 are made of a heat resistant, insulated lightweight material associated with a standard bathtub, such as Formica, porcelain and the like. The shape of the first bathtub 103 and second bathtub 115 is in the shape of a typical elongated elliptical bathtub. However, the shape of the first bathtub 103 and the second bathtub 115 can have a circular shape, a triangular shape, a rectangular shape or any other shape known to those of ordinary skill in the art. First bathtub 103 includes the left side portion 105a, a right side portion 105c, front side portion 105d and the back side portion 105b. Second bathtub 115 is disposed around a bottom portion of the first bathtub 103, where the left side portion 105a, right side portion 105c, front side portion 105d and the back side portion 105b is located in an open space between the second bathtub 115 and the first bathtub 103.

Within the left side portion 105a, right side portion 105c, front side portion 105d and the backside portion 105b are respective left side opening 107a, a right side opening 107c, front side opening 107d and the backside opening 107b. The left side opening 107a, right side opening 107c, front side opening 107d and the backside opening 107b are air inlets or vents that allows air, steam, vapor or the like to flow out from the side portions 105a-105d of the bathtub system 101. A plurality of openings each side of the bathtub system 101 is represented by left side opening 107a, right side opening 107c, front side opening 107d and back side opening 107b.

Switch 109 is a standard switch utilized to turn the bathtub system 101 ON or OFF. Also, the switch 109 is mechanically or electrically connected or coupled to valve 111 with a swingable flap 111a so that when the switch 109 is turned ON the flap 111a opens up to allow a person to pour a plurality of liquids into the side portions 105a-105d of the bathtub system 101. For example, the plurality of liquids can be water, medicinal oil, herbal oil, or essence oil that is poured into the bathtub system 101. Also, the switch 109 is electrically connected by an insulated non-conductive wire 109a or wirelessly connected to the heating device 113. Located next to the switch 109 is an electronic timer 117 that is electrically or wirelessly connected to the heating device 113, whereby the electronic timer 117 transmits instructions to the heating device 113 on how long the plurality of liquids should be kept at a certain temperature. For example, when a user turns a dial or presses buttons on the electronic timer 117 to continuously heat the bathtub system 101 for a period of time and a specific temperature, then the electronic timer 117 transmits a message to the processor of the heating device 113 to continuously heat the plurality of liquids for an hour at a temperature of 120 degrees Celsius. The range of time the user can choose to heat the bathtub system 101 can be anywhere from 5 minutes to 8 hours and the temperature is in the range of 100 degrees to 150 degrees Celsius. In another embodiment, the electronic timer 117 can inform the heating device 113 to intermittently heat the bathtub system 101, for example for 1 hour with 5 minute breaks at a temperature of 100 degrees Celsius.

The heating device 113 is a typical heater or heating device utilized to heat up liquids. Heating device 113 is located underneath a bottom portion of the first bathtub 103 and a top portion of second bathtub 115. In another embodiment, the heating device 113 may be located in any portion of the bathtub system 101. The heating device 113 includes a memory, a processor, a storage device and the typical components associated with a computer, a personal digital assistance and the like, where the heating device 113 includes a software program in the memory, storage or processor that is initialized to heat up the plurality of liquids. This software program or equation instructs the heating device 113 to heat up the liquids to a certain temperature for a particular time period when a particular amount of liquid is poured in through swingable flap 111a. The swingable flap 111a has a range of opening from 0 degrees being closed to 180 degrees being fully opened. In this case, switch 109 is utilized to fully open the swingable flap 111a in order to pour a plurality of liquids in the range of about 5-25 gallons or the liter equivalent of a mixture of water and medicinal oil into the bathtub system 101. Heating device 113 also includes a typical electrical thermometer 113a that measures the temperature of the plurality of liquids in order to determine how long the heating device 113 should be activated to heat the plurality of liquids. For this case, the temperature of the plurality of liquids is measured in Celsius, but it may also be measured in Fahrenheit or any standard temperature measurement.

The heating device 113 is covered by an insulating material, such as a silicon or any typical insulating material so the electrical components of the heating device 113 do not come in contact with the plurality of liquids in between the first bathtub 103 and the second bathtub 115. In another embodiment, a plurality of heating devices may be placed at different locations of the bathtub system 101 to heat up the plurality of liquids. A water measuring device 121 is electrically connected to the heating device 113 so that when the water measuring device 121 measures that, for example 10 gallons of water has been poured into the bathtub system 101, then the water measuring device 121 will transmit a message to the heating device 113 to become activated. The water-measuring device 121 may be the standard sharp-crested weir, short-throated flume, or submerged orifice or a typical device utilized to measure the amount of water or any type of liquid. When the bathtub system 101 receives the 10 gallons of water and medicinal oil, then the water measuring device 121 measures 10 gallons and instructs the heating device 113 to heat the water and medicinal oil for a period of time depending on the amount of liquids poured in the bathtub system 101. For example, when the 10 gallons of water and medicinal oil (plurality of liquids) is received by the bathtub system 101, then the heating device 113 begins to heat the plurality of liquids for approximately 2 hours to raise the temperature of the plurality of liquids to a range in between 100 to 150 degrees Celsius. The electrical thermometer 113a is utilized to determine the temperature of the plurality of liquids before the heating device 113 begins to heat up the plurality of liquids in order for the heating device 113 to determine how long it should be activated. The software program in the processor of the heating device 113 includes a database table that states how long the heating device should be activated depending on the temperature of the plurality of liquids and amount of the plurality of liquids. For example, if 10 gallons of the plurality of liquids at a temperature of 30 degrees Celsius is poured into the bathtub system, then the heating device 113 should be activated for 3 hours to raise the temperature of the plurality of liquids to 100-150 degrees Celsius. The standardized temperature conversion of Celsius to Fahrenheit can be used to transform the 100-150 degrees Celsius to its Fahrenheit equivalent.

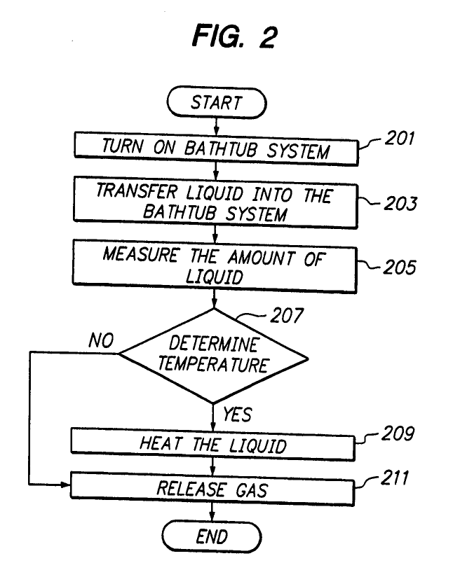

FIG. 2 is a flow chart that depicts a method of utilizing the bathtub system. At block 201, a person utilizing turns the bathtub system ON by turning the switch 109 to ON and the valve 111 opens up from totally closed at 0 degrees to being opened at 180 degrees. At this point, the person may choose to turn on the faucet 123 by turning the hot water mechanism 123a and/or cold water mechanism 123b to fill the first bathtub 103 with water or the person can wait until some later point to turn on the faucet 123, for example when the vapor is dispensed through the openings 107a-107d. Optionally, switch 109 includes a small computer that allows a person to specify the temperature the heating device 113 should heat the plurality of liquids to, for example 120 degrees Celsius.

Next, at block 203 a person transfers or pours a plurality of liquids through the valve 111 where the plurality of liquids are dispensed and received at the portions 105a-105d. The plurality of liquids may be only water or a mixture of water with a combination of medicinal oil, castor oil, essence oil or any liquid that is feasible to be placed into the bathtub system. At block 205, the amount of plurality of liquids is measured by the water-measuring device 121. This water-measuring device 121 as stated above, is electrically connected to the heating device 113. When the amount of plurality of liquids reaches a certain amount in the bathtub system 101, for example 10 gallons then the water-measuring device 121 transmits a message to the heating device 113 to begin heating the plurality of liquids.

At block 207, the processor of the heating device 113 determines the temperature of the plurality of liquids by utilizing the electronic thermometer 113a. If the temperature of liquid is equivalent to the temperature the user optionally requires, for example the plurality of liquids is at a temperature of 100 degrees Celsius and the user requested 100 degrees Celsius by utilizing switch 109, then the heating device 113 will turn ON and keep the plurality of liquids at the same temperature and goes to block 211.

On the other hand if the user requires the temperature of the plurality of liquids to be at 120 degrees Celsius and the current measured temperature of the plurality of liquids is 50 degrees Celsius, then the heating device 113 will heat up the plurality of liquids until the temperature of the plurality of liquids is 120 degrees Celsius. At block 209, the plurality of liquid is heated by the heating device 113 based on the amount of liquid received as per the water-measuring device 121. The processor of the heating device 113 includes a database table where depending on the amount of plurality of liquids received in the bathtub system 101 the plurality of liquid will be heated for a specific time to reach a specific temperature requested by the user. For example, the user requests the plurality of liquids have a temperature of 120 degrees for 10 gallons which requires the heating device 113 to heat the plurality of liquids for 2 hours.

At block 211, when the plurality of liquids rises to a certain temperature, for example 120 degrees then the gas, vapors or steam is released through the openings 107a-107d. The plurality of liquids may be heated to a range of 100-150 degrees Celsius or its Fahrenheit equivalent. Optionally, the user can utilize the electronic timer 117 to keep the water heated to 120 degrees Celsius for anywhere from 1 minute to 6 hours. This electronic timer 117, as stated above is electrically or wirelessly connected to the heating device 113, where the electronic timer 117 instructs the processor of the heating device 113 to remain ON for a certain period of time, for example 2 hours. After the plurality of liquids become vapors or steam, the person may turn ON the faucet 123 to disperse water into the first bathtub 103. When the person has finished utilizing the bathtub system 101, then he/she can turn the switch 109 OFF, which transmits a signal to heating device to turn OFF then the water cools. The plurality of liquids would then drain into the second bathtub drain 115a and this process ends.

This invention provides a user with a bathtub system that allows a person to enjoy a vapor or steam bathtub. The person is able to pour any desired plurality of liquids into the bathtub system, where the plurality of liquid will be transformed to a vapor or steam that is able to relax the person with asthma or stuffy nose by releasing gas, steam or vapor through the openings of the bathtub system. Also, this bathtub system can be utilized as a regular bathtub where the vapor portion of the bathtub system is not utilized.

It is intended that the foregoing detailed description be regarded as illustrative rather than limiting and that it be understood that it is the following claims, including all equivalents, which are intended to define the scope of the invention.

1. A method of utilizing a bathtub system comprising:
receiving a plurality of liquids;
heating the plurality of liquids based on a particular amount of the plurality of liquids received;
transforming the plurality of liquids into gas responsive to the plurality of liquids being heated to a certain temperature; and
releasing gas through a plurality of openings.

2. The method of claim 1, wherein the certain temperature is in the range of 100-150 degrees Celsius.

3. The method of claim 1, wherein the certain temperature is 100 degrees Celsius.

4. The method of claim 1, wherein the certain temperature is 150 degrees Celsius.

5. The method of claim 1, wherein the plurality of liquids includes water and medicinal oil.
